(19) United States
(12) Patent Application Publication
(10) Pub. No.: US 2022/0307146 A1
(43) Pub. Date: Sep. 29, 2022

(54) Electrolysis System and Method

(71) Applicant: Energyne Pty Ltd, Murwillumbah South (AU)

(72) Inventors: Ron Campeanu, Murwillumbah South (AU); Thomas Campeanu, Murwillumbah South (AU)

(73) Assignee: Energyne Pty Ltd, Murwillumbah South (AU)

(21) Appl. No.: 17/753,028

(22) PCT Filed: Aug. 28, 2020
(86) PCT No.: PCT/AU2020/050906

§ 371 Date: Feb. 15, 2022

(30) Foreign Application Priority Data
Sep. 3, 2019 (AU) 2019903244

(51) Int. Cl. C25B 9/65; C25B 15/08; C25B 1/04; C25B 15/023

(52) U.S. Cl. CPC C25B 9/65; C25B 15/08; C25B 1/04; C25B 15/023

(57) ABSTRACT

An electrolysis system, comprising a power supply configured to provide an input voltage; and a controller configured to receive the input voltage and output a pulse width modulated voltage, the output voltage being a 30V square wave having a variable duty cycle in the range of 1% to 10%. The system further comprises at least one electrolysis cell configured to receive the output voltage, each electrolysis cell comprising a plurality of metal plates, each electrolysis cell being configured for receiving water containing an electrolyte to split the water when the output voltage is received.

### REFERENCE TO RELATED APPLICATION(S)

This application claims Convention priority from Australian Provisional Patent Application No. 2019903244, filed 3 Sep. 2019, hereby incorporated by reference in its entirety as if fully set forth herein.

### TECHNICAL FIELD

The present invention relates generally to electrolysis of water into hydrogen and oxygen and, in particular, to a system and method of performing electrolysis in an energy efficient manner.

### BACKGROUND

Electrolysis is the process of using electricity to split water (H₂0) into hydrogen (H₂) and oxygen (O₂) gases. Environmental concerns have increased interest in energy sources other than traditional fossil fuels and increased emphasis on energy efficiency. Hydrogen gas stores an energy of up to 142.925 MJ/Kg. As hydrogen gas can be converted into electrical energy, interest in using hydrogen as a method of storing energy is growing.

While methods of electrolysis to split water into hydrogen are known, these typically use a relatively high level of energy compared to the energy stored in the resulting hydrogen gas, or the electrical energy obtained by re-electrification of the resulting hydrogen gas.

### SUMMARY

It is an object of the present invention to substantially overcome, or at least ameliorate, at least one disadvantage of present arrangements.

One aspect of the present invention provides an electrolysis system, comprising: a power supply configured to provide an input voltage; a controller configured to receive the input voltage and output a pulse width modulated voltage, the output voltage being a 30V square wave having a variable duty cycle in the range of 1% to 10%; and at least one electrolysis cell configured to receive the output voltage, each electrolysis cell comprising a plurality of metal plates, each electrolysis cell being configured for receiving water containing an electrolyte to split the water when the output voltage is received.

According to another aspect, the input voltage is between 75 Vdc and 250 Vdc.

According to another aspect, the square wave has a frequency of 30 Hz.

According to another aspect, the at least one electrolysis cell comprises four electrolysis cells connected in parallel.

According to another aspect, a concentration of the electrolyte in the water is 100 g KOH per litre.

According to another aspect, each of the at least one electrolysis cells comprises fifteen neutral plates and 2 terminal plates, each of the terminal plates forming an end of the electrolysis cell.

According to another aspect, the input voltage is varied such that the voltage between each of the plates of the at least one electrolysis cell is in the range of 1.2V to 2V.

According to another aspect, the duty cycle is varied based upon voltage measured across the at least one electrolysis cell.

Another aspect of the present invention provides method of performing electrolysis, the method comprising: receiving, at a controller, an input voltage; generating, by the controller using the input voltage, a pulse width modulated output voltage, the output voltage being a 30V square wave having a variable duty cycle in a range of 1% to 10%; receiving, by at least one electrolysis cell, the output voltage, each electrolysis cell comprising a plurality of metal plates, each electrolysis cell being configured for receiving water containing an electrolyte to split the water when the output voltage is received.

Other aspects are also described.

### BRIEF DESCRIPTION OF DRAWINGS

At least one example embodiment of the present invention will now be described with reference to the drawings and appendices, in which:

FIG. 1 shows a system for performing electrolysis of water;

FIGS. 2A, 2B, 2C and 2D show circuit diagrams corresponding to the system of FIG. 1;

FIGS. 3A to 3H show structure of an electrolysis cell of FIG. 1;

FIG. 4 shows test of results from operation of implementations of a system for performing electrolysis of water;

FIG. 5 shows an example method of setting a duty cycle for electrolysis implemented by the system of FIG. 1;

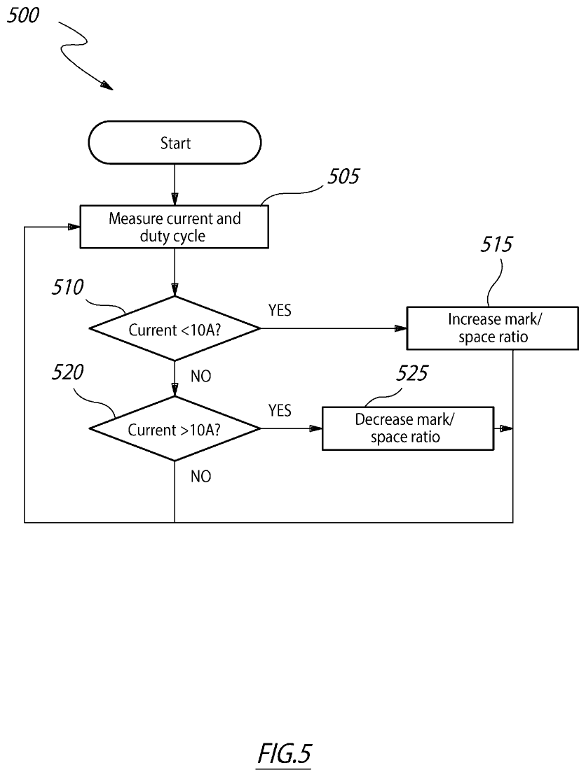

Appendix A shows data measured for tests used in generation of FIG. 4A;

Appendix B shows data measured for tests using different concentrations of electrolyte;

Appendix C shows data measured in a battery recharge test; and

Appendix D shows data measured in a fuel cell operation test.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Electrolysis is the use of electricity to split water into hydrogen and oxygen gases and is the subject of increasing research as hydrogen gas can be converted to electrical energy. The arrangements described provide a solution for performing electrolysis using less energy by using a relatively low duty cycle, a departure from traditional solutions. The relatively low duty cycle is achieved by means of using relatively high input voltage and pulse width modulation.

Hydrogen has been shown to store 142.925 MJ/kg (See Glasstone & Lewis, Elements of Physical Chemistry (Macmillan 2^{nd} ed, 2006) 82 “Formation of liquid water from its elements at 25 deg C.”). Electrolysis of water means that enthalpy is gained from an external source (the application of electrical energy) to disassociate liquid water into its components of hydrogen and oxygen gases. The density of hydrogen gas is 0.089286 g/L (2 grams per mole/22.4 L).

Equations (1) and (2) below show the relationships between water and hydrogen and oxygen gases in terms of weight.

1 mole (2 g) H2 gas+½ mole (16 g) O2 gas ↔1 mole (18 g) H₂O (liq) (1)

500 moles (1 Kg) H2 gas+250 moles (8 Kg) O2 gas ↔500 moles (9 Kg) H₂O (liq) (2)

One mole (molecular weight) of hydrogen gas weighs two grams. Accordingly, there are 500 moles in a kilogram of hydrogen gas. One mole (2 grams or 22.4 L) of hydrogen stores 285.85 KJ of energy. Therefore, one kilogram of hydrogen gives 500×285.85 KJ=142.925 MJ (MegaJoules)/Kg H₂.

As 0.28 KWh is equivalent to 1 MJ of energy, 3.573 Wh/L (142.925 MJ/Kg H2×0.28=40.019 KWh/Kg=40019/500/22.4=3.573 Wh/L H2) is the maximum energy available from hydrogen gas when used direct for combustion or other chemical use. However, when used to produce electricity from a fuel cell, the value typically reduces considerably.

Electrolysis also involves water and oxygen. The corresponding quantities and measurements for oxygen and water are provided below:

### Oxygen Gas:

32 grams per mole

### Moles per Kilogram=1000/32=31.25

Density; 32/22.414=1.428 g/L at Standard Temperature and Pressure (STP) of 0 degrees Celsius, 1 atmosphere.
Water (liquid state):
18 grams H₂O (liquid) is 1 mole
Accordingly, 500 moles H₂+250 moles O₂↔500 moles H₂O.
In terms of weight, 500 moles×18 g/mole gives 9000 grams H₂O for each one kilogram of hydrogen gas.

As described above, 3.573 Wh/L is the maximum energy available from hydrogen gas when used directly for combustion or other chemical use. However, when hydrogen gas is used to produce electricity from a fuel cell for example, a relatively high amount of energy loss is observed.

A fuel cell operating at an example of 50% efficiency reduces the energy received from the hydrogen as electricity to 3.573×0.5=1.7865 Wh/L hydrogen.

If the conversion of hydrogen involves use of an inverter to obtain an AC supply from a DC supply, the efficiency of the inverter also affects the electrical energy obtained from the hydrogen gas. For example, an inverter operating at 90% efficiency reduces the electrical energy obtained to 1.7865×0.9=1.6078 Wh/L hydrogen.

Returning to the electrolysis process, losses by heating of the water being split has a relatively significant effect on the efficiency of an electrolyser. If water in an electrolyte solution is allowed to heat sufficiently to partially form water vapour, the energy required to split the water into hydrogen gas and oxygen is unnecessarily increased and efficiency of the electrolysis system is reduced.

Reducing the amount of electrical power consumed by an electrolysis system is becoming increasingly important, both in terms of cost and energy trends due to environmental concerns. Furthermore, reducing the amount of power consumed in performing electrolysis typically reduces the strain on electrical infrastructure, such as electrical transmission lines and generation facilities.

One way of reducing the amount of electrical power consumed by an electrolysis device is to reduce the current supplied to the electrolysis device. Electrolysers operate normally within a supply voltage range which can be less than the nominal supply voltage. For example, an electrolyser which is designed to work at an example of 230 Vac (Volts alternating current) or 230×2=325 VDC (Volts direct current) typically operates at voltages as low as 194 VDC or 1.2 VDC per 2-plate compartment in the electrolyser cells 106. However, reducing the supply voltage to a water electrolysis device will often result in a reduced output volume of gases, hydrogen and oxygen.

Various voltage control systems exist, for example utilising a combination of transformer-based technology, and smoothing circuits. Electronic switching devices such as silicon controlled rectifiers (SCR) may be used to reduce supply voltage to suit the size of an electrolyser device while pulse-width modulators utilising insulated gate bipolar transistors (IGBTs) or metal oxide semiconductor field effect transistors (MOSfets) may be used on a direct current (DC) supply. The DC current may be supplied by an alternating current source and rectifier system or from a DC source.

Known electrolyser devices are typically limited in efficiency. Known electrolyser devices designed based on grid rectified and unsmoothed voltages usually include an electrolysis cell that includes a number of metal plates. The electrolyser devices have a fixed plate-number to voltage ratio. Therefore, grid rectified unsmoothed voltages used in electrolyser designs are not ultimately suitable for widespread applications in energy reduction solutions. Using an incoming AC frequency of 50 Hz or 60 Hz, plain fully rectified AC, produces (unsmoothed or unfiltered) DC at a frequency of 100 Hz or 120 Hz as each lower axis half wave is inverted by a full bridge rectifier.

Another device typically used for voltage control is a variac. Variacs allow for their rated current at a wide range of voltages (typically 0-260 VAC rms). Variacs may be used in laboratory testing for example, but are typically considered an impractical and prohibitively expensive solution for some applications which require only an isolated range of voltage.

Variacs are generally expensive devices, constructed from an iron core with a winding/s of copper. Due to normal reactive energy, variacs typically lose energy as heat. Variacs are also relatively heavy and bulky devices. Unless voltage regulation is used the fluctuating grid voltage will affect electrolysis and the gas production rate.

The arrangements described may use grid energy converted from alternating current to direct current by a rectifier (diodes) and, as may be required, the addition of smoothing capacitors to reduce ripple voltage after rectification. Rectifiers are relatively light and small in size, much cheaper than variacs and are not as prone to losing reactive energy to waste as heat.

As described hereafter, assuming that the control transistors are correctly rated for the input voltage, that is, the specified MOSfet voltage is greater than 400 V, but preferably higher such as around 650 V, any grid input voltage is controlled using pulse width modulation to allow a voltage of around 30 VDC (selv, standard extra low voltage, any voltage AC or DC below 40 V) to be applied to electrolyser cells.

Preferred arrangements use isolated grid energy if using a grid source (1:1 isolation transformer/s). Isolation transformers inductively decouple load energy from neutral/earth linked mains (MEN or Multiple Earth Neutral mains).

### System Overview

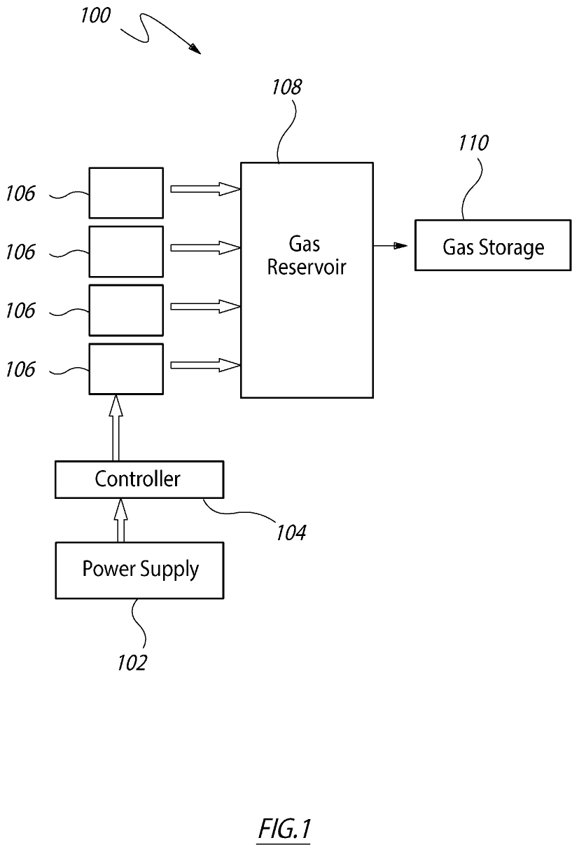

FIG. 1 shows a system 100 for electrolysis of water. The system 100 comprises a power supply 102, a controller 104, a number of electrolysis cells 106 and a reservoir 108. Typically, a vertical stack of between 1 and 5 cells 106, is used. A solution of electrolyte in water is pumped or flows statically to the electrolyser cells 106. Hydrogen and oxygen gases resulting from electrolysis of the water are provided to the reservoir 108, in some instances with some of the electrolyte solution.

The power supply 102 is configured to generate an input voltage (also referred to as a supply voltage) in a range of approximately 75 VDC to 250 VDC. The power supply 102 may be one of a battery bank, a grid supply with a rectifier system or the like. In the example arrangements described the power supply 102 is a battery bank.

The input voltage is selected to be sufficiently high to enable a duty cycle in the range between approximately 1% and 10% to be used, but with a sufficient voltage generated across plates of the electrolysis cells 106 to cause electrolysis of the solution and transfer gases to the reservoirs 180. The resultant square wave has a relatively narrow peak width and is applied at a frequency determined through experimentation.

Water can split via electrolysis at a relatively low voltage. However, the volume of gases produced will also be relatively low. As the voltage between any two plates rises sufficiently (greater than approximately 1.2 V), a suitable trade-off between voltage and gas production can be determined. Using voltage that is overly high (overvoltage, greater than approximately 2.5 V across two plates) across a cell can result in production of heat and efficiency of hydrogen gas production will decrease.

Preferably, an electrolysis system will run to limit heat loss while producing hydrogen gas. Tests have shown that to increase gas production, increasing the number of cells, rather than cell voltage or current and maintaining a relatively low duty cycle is beneficial.

The controller 104 is configured to receive the input voltage generated by the power supply 102. The controller 104 is configured to use pulse width modulation to generate a direct current square wave output voltage having a duty cycle of between approximately 1% and 10%, an amplitude of approximately 30 VDC and a frequency of approximately 30 Hz. The duty cycle range of about 1% to 10% and the frequency of about 30 Hz have been determined through experimentation. Other ranges within these approximate bounds may be suitable for particular implementations, for example ranges between 2% and 9%, 3% and 8%, 5% and 10% and the like. Other frequencies may be used depending on factors such as electrolyte concentration, input voltage level and the like.

The controller 104 includes circuitry suitable to (i) reduce the amplitude of the input voltage to 30 VDC and (ii) pulse width modulate the input voltage to achieve a square wave with a duty cycle between 1% and 10% and a frequency of 30 Hz. The controller 104 can include circuitry for reducing input DC current such as a microcontroller, for example an AVR microcontroller. An alternative arrangement can use a microcontroller connected via an input capture pin (ICP) to measure the rise and drop times and accordingly duty cycle. The microcontroller can for example be connected to a beaglebone arm family microprocessor running Linux as a further processing device for screen and remote transfer via Ethernet. The beaglebone microprocessor could execute instructions coded in Python™ to control duty cycle. Alternatively, an iPhone™ executing an application such as WiPry™ could be used to measure and control duty cycle.

If the input voltage provided by the power source is alternating current, the controller 104 can include a full wave rectifier (unsmoothed) for alternating current (duty 100%), a half wave rectifier (unsmoothed) for alternating current (nominal duty 32%), a full wave rectifier for alternating current including a system of capacitors (smoothed), a half wave rectifier for alternating current including a system of smoothing capacitors or the like. Alternatively, the alternating current may be rectified at the power source 102.

The controller 104 also includes circuitry suitable for implementing pulse width modulation. The pulse width modulation circuitry may comprise a system of transistors such as insulated gate bipolar transistors (IGBTs), metal oxide semiconductor field effect transistors (MOSfets). In some implementations, the controller comprises one or more assemblies of each type of transistor. The controller 104 may further comprise a device such as a 555 timer or, preferably, a microcontroller configured to implement pulse width modulation on the received input voltage. In some arrangements, the controller 104 is a digital microcontroller comprising an ethernet module for connection to a web client for enabling data control and data storage. The microcontroller can additionally incorporate functions such as RS485 and I2C communication ability, display connections and the like. An example of a suitable type of microcontroller is an AVR microcontroller produced by Atmel. Others by Infineon Technologies, Renesas Electronics or other semiconductor companies. The microcontroller can be programmed using languages such as C/C++, assembler and Python™ The controller 104 may also comprise a system for temperature control of the transistors such as a heatsink. The heatsink may achieve cooling via a fan, natural cooling, or static thermal reduction or the like.

The controller 104 operates to reduce the input voltage such that the output voltage is appropriate for the number of metal plates of the electrolyser cells 106. It is known in practice that a suitable voltage range for electrolysis is from 1.24 V to 2 V per single cell or between any two metal plates of the cells 106. However, approximately 2 V is a preferred implementation as determined through experimentation.

The duty cycle output due to pulse width modulation can be varied in some implementations as described below in relation to FIG. 5. The smaller the ratio of pulse width to the total cycle time (that is, the lower the duty cycle), the lower the energy and the less the volume of hydrogen gas produced.

In implementations where the duty cycle is variable, the controller 104 includes a voltage sensor circuit for detecting a voltage at the electrolysis cells 106. The voltage sensor communicates voltage level detections (readings) in a form that includes an array of cell modules to the pulse width modulation circuitry (for example the microcontroller with ethernet connection). The voltage sensor is used to measure duty cycle (mark/space ratio) across the electrolysis cells.

Additionally, the controller 104 includes a current sensor for detecting a current at the electrolysis cells 106. The current sensor communicates current level detections (readings) in a form that includes an array of cell modules to the pulse width modulation circuitry (for example the microcontroller with ethernet connection). Operation of a method using current is described in relation to FIG. 5. The readings can be transmitted wirelessly or by wired communication depending on the implementation and are used to adjust the pulse width modulation.

The current sensor for direct current is preferably a hall device to measure current flowing to the one or more electrolysis cells 106. A Current Transformer (CT), cannot be used for DC based applications. PWM of direct current is direct current, even though the pulse can be provided to a transformer. The current readings taken by the hall device are returned to the microcontroller of 104 to maintain the current at a desired level.

The controller 104 applies the output voltage to the electrolysis cells 106. Each of the electrolysis cells 106 is configured for placement in the reservoir 108. Each of the cells 106 may be oriented horizontally or vertically, with combined gas going to appropriate hydrogen or oxygen reservoirs 108. Hydrogen and oxygen reservoirs must remain separate or else the gases will mix. If more than one electrolysis cell 106 is used, the cells are connected in parallel. In preferred arrangement, four (4) (or more) of the electrolysis cells 106 are used in a vertical arrangement.

In the arrangements described, each of the electrolysis cells 106 comprises fifteen metal plate arrangements also referred to as neutral plates, and two metal plates referred to as terminal plates. The number of neutral plates can be varied based on the input voltage or other aspects such as electrolyte concentration, membrane/mesh characteristics (membranes are described in relation to structure of electrolysis cells below). More neutral plates means a higher voltage must be used to obtain around 2 V across any two plates. Otherwise, gas production will be affected. Too high a compartment voltage across plates results in heating (waste energy), while too low a compartment voltage results in less gas production, also inefficient. Too low an electrolyte concentration results in higher internal resistance and heating. The required electrolyte concentration can relate to a mesh hole size for a membrane being used.

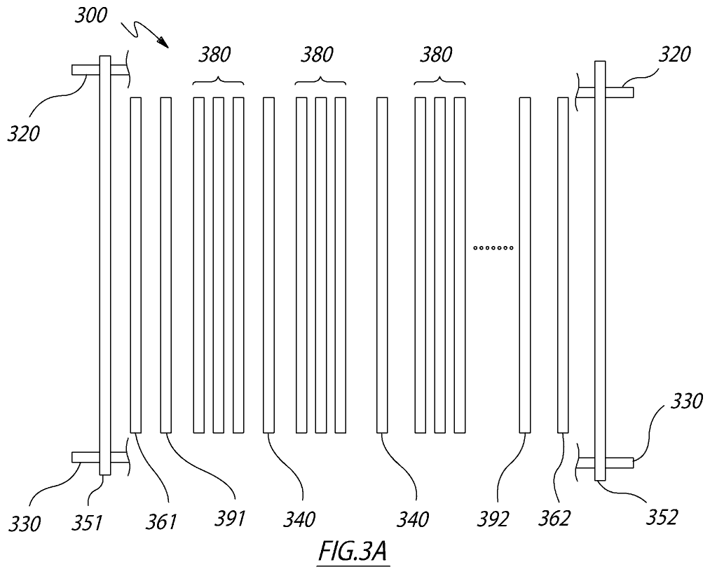

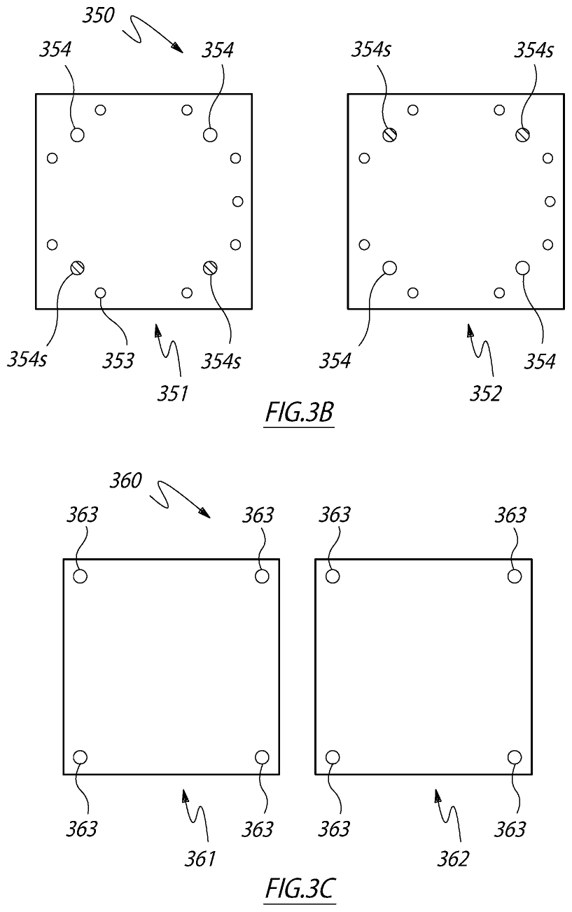

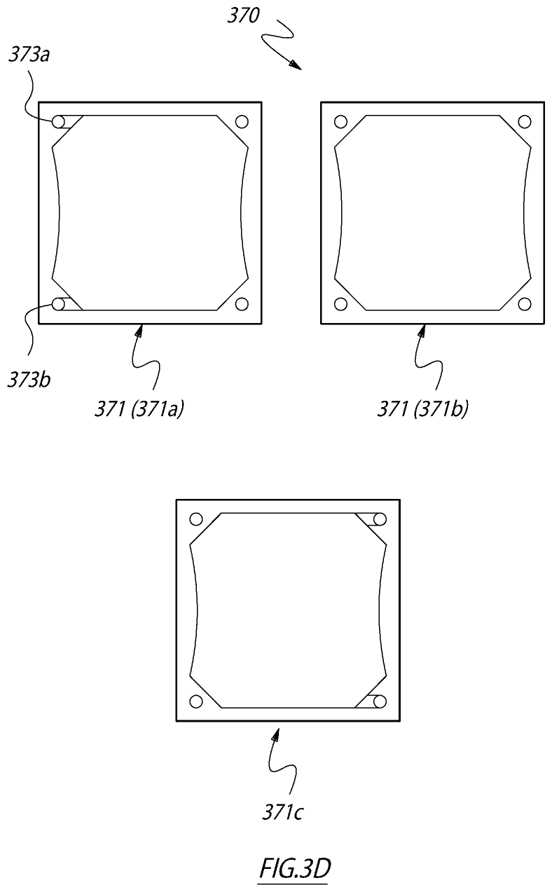

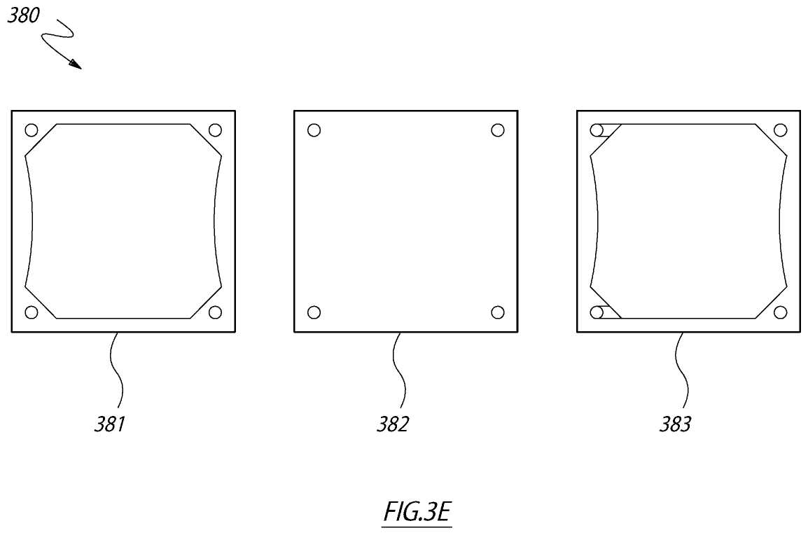

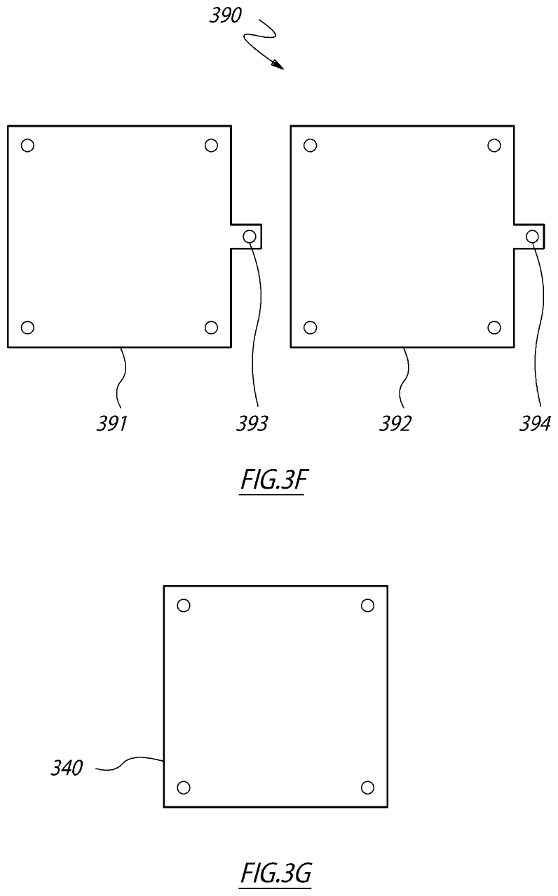

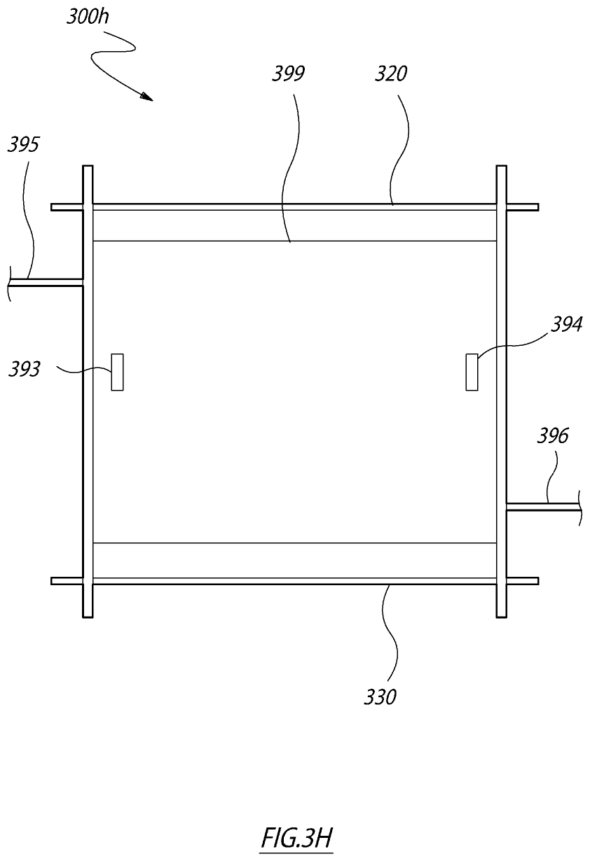

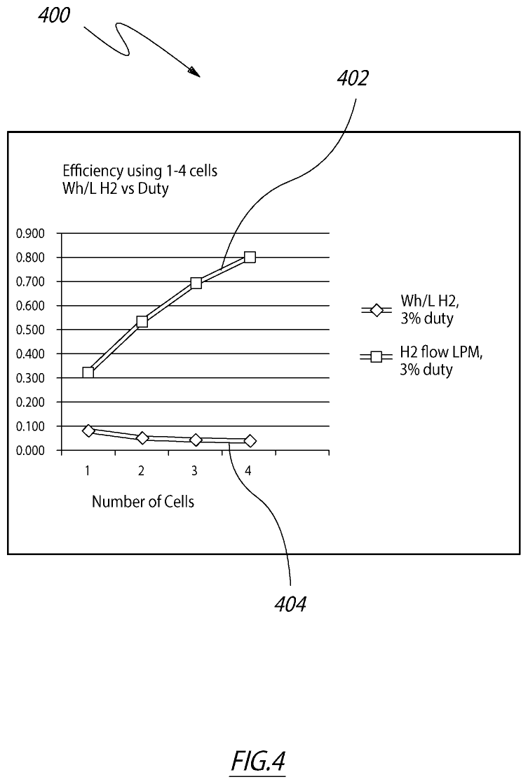

Detailed structure of each electrolysis cell is described below with reference to FIGS. 3A to 3G. The preferred voltage and duty cycle ranges described herein are determined based on generation of hydrogen gas so that heat losses can be reduced compared to larger duty cycles and/or lower input voltages. Input voltage affects efficiency as input voltage impacts on what duty can be generated. Similarly, electrolyte concentration affects efficiency as a lower electrolyte concentration results in less hydrogen being generated, produces more heat and requires a higher input voltage than a higher electrolyte concentration (see Appendix B).

Application of the modulated input voltage to the electrolysis cells 106 operates to apply a voltage between the plates of each of the cells 106. If the voltage between the plates is of a suitable level (1.24 VDC to 2 VDC) and the electrolyte is of suitable concentration in the water, electrolysis will occur and the water will split into hydrogen and oxygen gases.

The concentration of electrolyte in water provided to the cells 106 affects ion flow and accordingly the rate of electrolysis. The electrolyte used is typically potassium hydroxide (KOH). The KOH is dissolved in preferably either industrial distilled water, solar distilled water, de-ionised water or filtered/processed rain water caught from a non-metallic roof and analysed for impurities before use. Concentration of the KOH solution can vary from very low at 0.5% to 30% KOH. The inventor has found that a 10% w/w KOH solution is adequate, but that higher concentrations will also work. In a preferred arrangement, an electrolyte concentration of at least 100 g KOH per litre is used.

If more than one electrolysis cell 106 is used, each of the cells 106 is connected in parallel. In a preferred arrangement, four (4) electrolysis cells are used. Tests using one to four cells in a parallel vertical arrangement, were conducted, the results of which are shown in FIG. 4A. As shown in FIG. 4A, increasing the number of cells was observed to increase the volume of hydrogen gas generated and improve efficiency.

### Effect of Operation

Electrical energy input to the electrolyser system 100 is proportional to the output volume of hydrogen gas. Use of multiple electrolysis cells 106 comprising a suitable number of individual cell plate pairs provides for a spreading of thermal load. The spreading of thermal load causes a lessening of loss of energy through thermal dissipation into the electrolyte solution. A system whereby a supply power is connected to one or more cells produces an effect whereby an electrical load across multiple cells results in load sharing across multiple cells producing a reduction in heat and an improved dissipation into the electrolyte solution and improvement in overall efficiency.

Use of the output voltage at the level of 30 VDC and low duty cycle allows sufficient voltage for the water molecules to split, forming hydrogen and oxygen gases. The relatively low duty cycle allows the electrolysis to occur while limiting transfer of energy from the metal plates to the electrolyte solution as heat. If the solution in the reservoir is allowed to heat to a degree that the water starts to vaporise, the amount of energy required to perform electrolysis increases as a consequence. As a result, the rate of generation of hydrogen gas is affected in an undesirable manner. Efficiency of the electrolysis system in terms of electrical energy used versus inherent energy stored in resulting hydrogen gas correspondingly decreases.

Further, allowing the water to heat to a degree that the water starts to vaporise can contaminate the gas (hydrogen) generated by the water vapour. The contamination results in drying material being required or at least a need for increased drying.

Application of the output voltage to the cells results in generation of hydrogen gas which is provided to a storage system, which may be any storage system suitable for hydrogen gas.

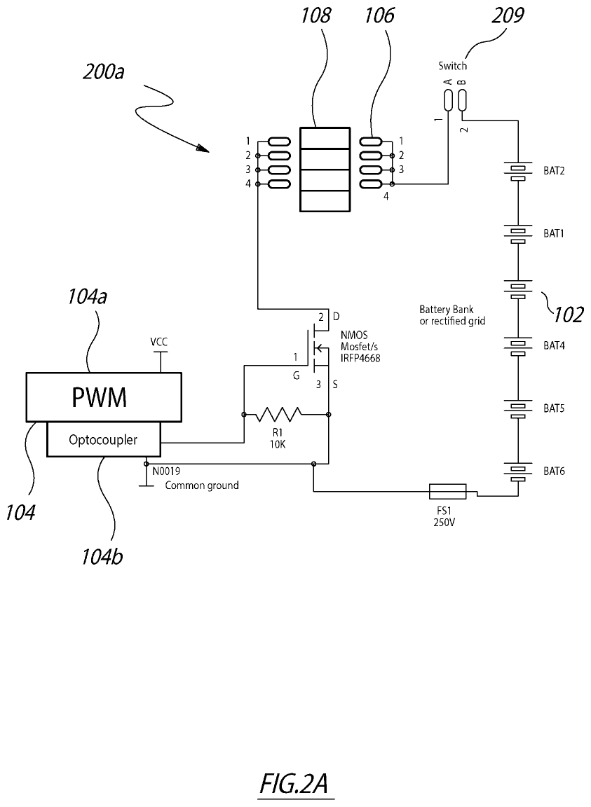

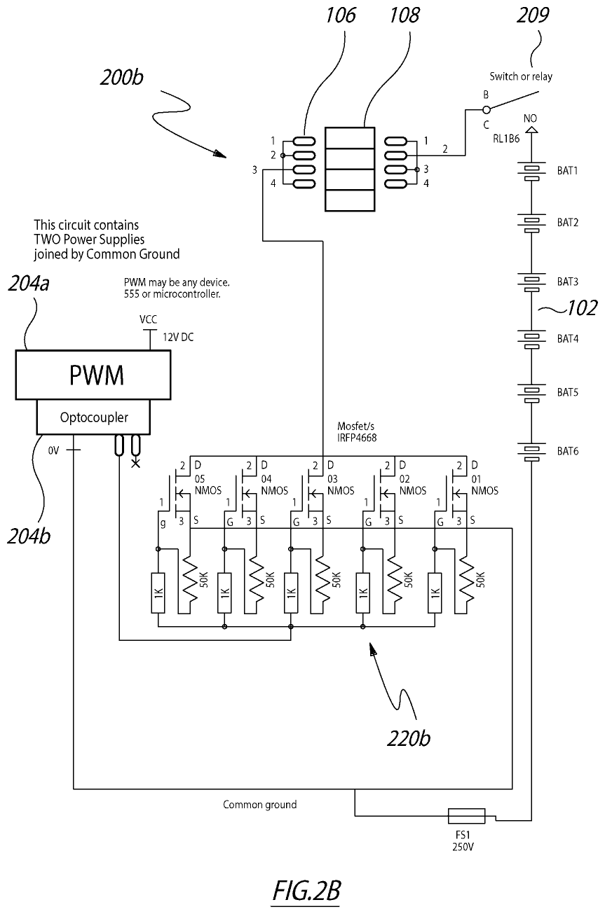

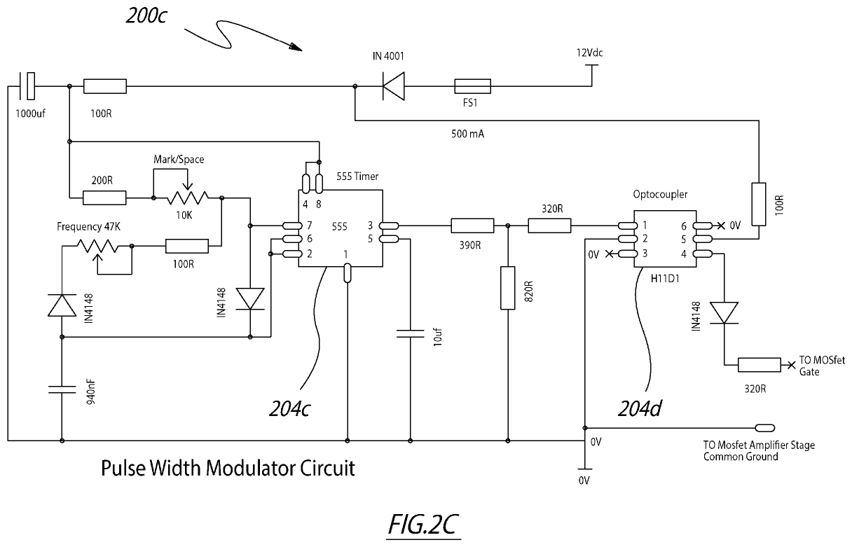

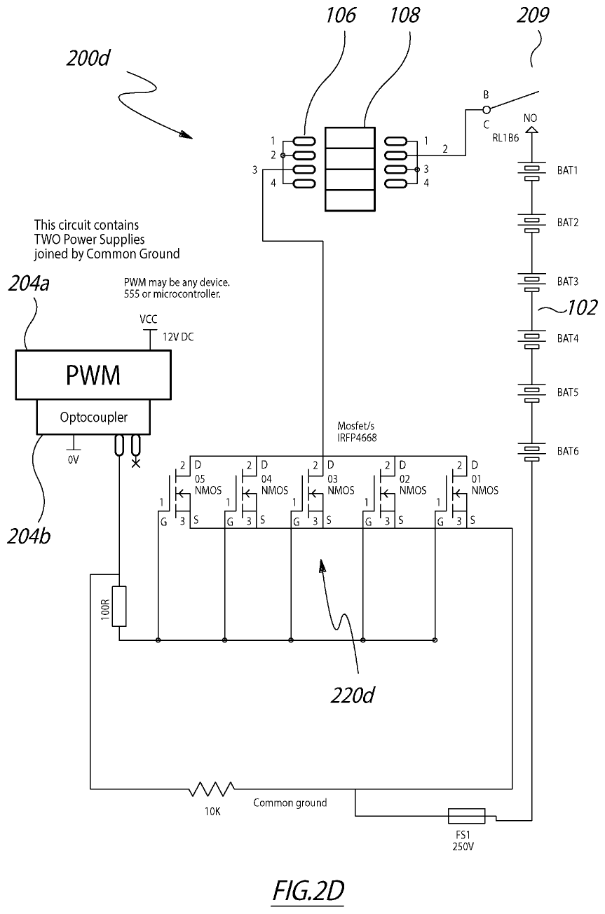

FIG. 2A shows a circuit 200a corresponding to the system 100 of FIG. 1. In FIG. 2 the power supply 102 is a set of batteries. The controller 104 is implemented as a PWM device 104a and an optocoupler 104b. The PWM device 104a can be a 555 timer or a microcontroller. The PWM device 104a typically also controls frequency. For example, if the controller 104a is a 555 timer device, the controller can be used in association with a 940 nF timing capacitor to achieve the desired frequency of operation.

FIG. 2B shows an alternative circuit diagram 200b of the system 100. In the circuit 200b the pulse width modulation of the controller 104 is achieved using a 555 timer 204a, an optocoupler 204b and 5 power n-type MOSfets Q1 to Q5 connected in parallel. The example circuit 200b uses resistors of exactly 50 KOhm each which is connected in parallel resulting in a resistance of 10 KOhm for each of the power MOSfets Q1 to Q5. An example of a suitable MOSfet is an IRF4668, rated for 200V and 130 A with a very low transistor drain-source resistance of 8 mOhms. In some implementations, particularly where the input voltage is at the high end of the range of 75 V to 250V, high power/precision MOSfets are preferably used such as SK165MBBB060, SK300MB080, SK280MB10 and SKM180A020 manufactured by Semikron International GmbH for example.

FIG. 2C shows an alternative circuit diagram 200c for performing pulse width modulation in the system 100. In the circuit 200c the pulse width modulation of the controller 104 is achieved using a 555 timer 204c and an optocoupler 204d. The circuit 200c shows the pulse width modulation control circuitry only and does not show connections to the electrolyser cells 160 or transistors Q1 to Q5 for ease of reference.

FIG. 2D shows an alternative circuit diagram 200d of the system 100. In the circuit 200d. the circuit 200d is similar to the circuit 200b but uses a different switching arrangement 220d compared to an arrangement 220b in FIG. 2B. in FIG. 2D, the pulse width modulation of the controller 104 is achieved using the 555 timer 204a, the optocoupler 204b and the arrangement 220d of 5 power n-type MOSfets Q1 to Q5 connected in parallel. In contrast to the circuit 200b, the example circuit 200d does not use resistors connected in parallel for each of the power MOSfets Q1 to Q5. An example of a suitable MOSfet for the circuit 200d is an IRF4668, rated for 200V and 130 A with a very low transistor drain-source resistance of 8 mOhms. In some implementations, particularly where the input voltage is at the high end of the range of 75 V to 250V, high power/precision MOSfets are preferably used such as SK165MBBB060, SK300MB080, SK280MB10 and SKM180A020 manufactured by Semikron International GmbH for example.

Measurements can be made across components of the circuits 200a, 200b and 200d using devices such as oscilloscopes (e.g., 100 MHz type), ammeters (hall clamp type) and the like.

Examples of the optocoupler 104b or 204b include an 4N25 (30 V) or H11D1 (300 V type). The optocoupler is preferably separated from direct connection to the power MOSfets Q1 to Q5. As shown in FIG. 2A a common ground connects the components of the circuit.

In FIGS. 2A, 2B and 2D the input voltage supply 102 is a battery bank. The battery bank fuse can be a standard ferrule type service fuse 125 A for example or replaced with a 50 A wire fuse. Suitable cabling can be in the region of 8 sqmm to 12 sqmm or greater in diameter.

FIG. 5 shows an example method 500 of controlling a duty cycle to allow electrolysis to be performed. The method 500 can be implemented by the controller 104 if the controller 104 comprises a suitable microcontroller/microprocessor.

The method 500 starts when the system 100 is switched on. For example, a switch 209 (see FIG. 2A) can be closed to close the circuit 200.

The method 500 starts at a measuring step 505. At step 505, the current and duty cycle across each of the electrolysis cells 106 is measured. The current can be measured by an ammeter connected between the controller 104 and the cells 106. Alternatively, a Hall effect sensor (clamp) can be used. The duty cycle can be set by the microcontroller 104. The duty cycle be initialised at a default value, for example a 2% or 0.02 duty factor upon the switch 209 being closed. Alternatively, the switch 209 can be closed and then the Gate supply to the MOSfets Q1 to Q5 switched on to softstart the circuit by increasing mark/space slowly to increase duty to the default value.

The microcontroller continues from step 505 to a first current check step 510. At step 510 the microcontroller determines if the measured current is less than a predetermined settable threshold. The threshold is in the example of FIG. 5. The settable threshold current relates to sufficient current to allow a reasonable rate of electrolysis to take place in the electrolyte solution and accordingly can depend on factors such as electrolyte concentration, cell structure (number of plates or type of membrane), and the like. If the microcontroller determines that the current is less than the threshold (YES at step 510), the microcontroller continues to an increase mark/space ratio step 515.

At step 515 the controller adjusts the pulse width modulation of the input voltage by increasing the mark/space ratio of the output voltage, effectively increasing the duty cycle. The increase can relate to a certain proportion of the present mark/space ratio (the duty cycle), for example an increase in the region of 5% to 20% of the present duty cycle depending on the granularity of control required. Alternatively, the mark/space ratio may be increased by a fixed amount, for example increased by 1%. After implementation of the step 515, the microcontroller continues to step 505. The maximum allowable duty cycle can relate to cell plate area as cell plate area effects current limit before undue heating. Typically, as a guide, the maximum current is held to around 0.3 A/6 sqcm for the entire 15 neutral-plate cell (106) in a stack of four cells. In determining maximum current, consideration can be made for a plate surface of one neutral plate, rather 15 plates or more. The reactive area on one plate can be measured. Preferably, more electrolysis cells 106 are used rather using brute force in terms of high current that results in heating. The maximum current can be determined based on the plate area of one plate only. One indicator of proof of efficiency will be that the system (electrolyser, transistors, wires) does not heat and does not require active cooling. If using a microcontroller the duty maximum may then be set. If the plates of the electrolysis cells heat, increased energy loss can occur. In practice, more cells 106 may be used in some implementations rather than overly increasing the current level.

If at step 510 the microcontroller determines that the current is less than the threshold (NO at step 510), the microcontroller continues to a second check step 520. At step 520 the microcontroller determines if the measured current is greater than the threshold. If the current is greater than the threshold (YES at step 520) the microcontroller proceeds to a decrease mark/space ratio step 525.

At step 525 the controller adjusts the pulse width modulation of the input voltage to decrease the mark/space ratio of the output voltage, effectively decreasing the duty cycle. The decrease can relate to a certain proportion of the present mark/space ratio, for example a decrease in the region of 5% to 20% of the present duty cycle depending on the granularity of control required. Alternatively, the mark/space ratio may be decreased by a fixed amount, for example decreased by 1%. After implementation of the step 525, the microcontroller continues to step 505.

If at step 520 the microcontroller determines that the current is less than the threshold (NO at step 510), the microcontroller continues to step 505. Step 505 can be repeated at periodic intervals, for example at the rising edge of each pulse of the square wave or at a predetermined periodic interval, preferably using an efficient hardware interrupt service routine, also known as an ISR. Hardware ISRs allow periodic data checking using main code to be avoided as hardware ISRs run outside the main program and are triggered by controller timer settings set by a programmer. Such implementations can avoid wasting code, increasing code volume and slowing down general operations. Inherent timer hardware functionality can be used.

FIGS. 3A to 3G show the structure of an example electrolysis cell 300. The electrolysis cell 300 provides an example of one of the electrolysis cells 106 of the system 100.

FIG. 3A shows a partial exploded side view cross-sectional view of the cell 300. The exploded cross-sectional view is not to scale relative to FIGS. 3B to 3G and is for illustrative purposes only.

The cell 300 comprises one of two end plates 351 and 352 at either end. The end plates 351 and 352 are of an insulating material such as plastic, typically high-density polyethylene (HDPE). The sealing gasket material is preferably silicone which is a thermoset polymer (or alternatively a thermoplastic type) at hardness of shore 60 A. A silicon can be used in red or white if costs are to be minimised. A general industrial EPDM (Ethylene Propylene Diene Monomers, typically more costly than silicone) is generally not used as the EPDM can leach impurities by decomposition and damage the cell 106. EPDM can be tested by gently simmering in water or 10% KOH solution. If no colour or decomposition occurs the EPDM may be used.

A sealing gasket 361 is placed on the inner side (the side facing the plate 352) of the plate 351 and a sealing gasket 362 is placed on the inner side (the side facing the plate 351) of the plate 352. An electrode plate 391 is placed on the inner side of the sealing gasket 361. Similarly, an electrode plate 392 is placed on the inner side of the sealing gasket 362. A gasket assembly 380 is placed on the inner side of the gasket 361 followed by a neutral plate 340. A sequence of gasket assembly 380-neutral plate 340-gasket assembly 380 is continued until a required number of neutral plates 340 are included between the electrode plates 391 and 392. In a preferred arrangement, fifteen neutral plates 340 are included in the cell 300. In the example of FIG. 3A only three gasket assemblies 380 and two neutral plates 340 are shown for ease of reference. A gasket assembly is included between the last (for example fifteenth) neutral plate and the electrode plate 392.

A connecting rod 320 and a connecting rod 330 (shown partially in FIG. 3A) are used to assemble the cell 300. The rods are threaded through the end plates 351 and 352 and used to form a compression sleeve holding the components of the cell 300 together. The rods 320 and 330 do not contact the metal plates of the cell 300 but are typically placed at least one centimetre from the metal plates.

In some implementations using multiple electrolysis cells, the end plates 351 and 352 are multiple times taller than the metal plates and gasket assemblies of the cell 300. Accordingly, using additional connecting rods 320 and 330, multiple cells 300 and be assembled at different heights along the plates 351 and 352. Prototype end plates used in testing 20 mm thick and 20×20 cm square.

FIG. 3B shows a set 350 comprising the portions of the end plates 351 and 352 that are in contact with the gaskets 361 and 362 respectively. Sets of holes (for example a hole 353) are formed in each of the plates 351 and 352. The holes may be round or oval or another shape. In particular four inner, relatively larger holes indicated as 354 and 354s are formed in each of 351 and 352. Each of one set of either the holes 354 or 354s is used to form a thread to receive a fluid/gas connector. For example in FIG. 3B, two of the holes 354 (each on the same end of the corresponding end plate) are used for receiving a fluid/gas connector through the plate 351 and the opposite end holes 354 are used for receiving a fluid/gas connector through the plate 352. In the example of FIG. 3B, the holes 354s marked with on the lower end of the plate 351 are sealed, for example using a screw, as indicated with diagonal patterning. Alternatively, the plate 351 may not have the holes 354s formed therein. In the example of FIG. 3B, the holes 354s marked with on the upper end of the plate 352 are sealed, for example using a screw, as indicated with diagonal patterning. Other methods to a screw may be used to seal the holes 354s may be used. Alternatively, the plate 352 may not have the holes 354s formed therein. The connector is typically formed of glass reinforced polyamide, stainless steel or another substance suitable for use in pumping/transferring electrolyte to the cell 300 and gases (or a gas/electrolyte mixture) to the reservoirs 108. The electrolyte solution is pumped/transferred through the connector to the cell 300. A single design is required as the plates 351 and 352 are symmetrical. As shown in FIG. 3B, the plates 351 and 352 are in opposite orientation to one another.

One plate, for example the plate 351 is positioned at one end of the cell 300. The other plate, 352, is positioned at the opposite end of the cell 300 as shown in FIG. 3A. Together the plates 351 and 352 form a compression sleeve to hold an assembly of electrodes and gaskets.

FIG. 3C shows a set 360 of sealing gaskets. The set 360 comprises a gasket 361 and a gasket 362. Each of the sealing gaskets 361 and 362 is fitted to one of each of the end plates 351 and 352. For example, the gasket 361 is placed on the plate 351 and the gasket 362 is placed under the plate 352. Holes 363 are formed in each of the gaskets 361 and 362. The holes 363 line up with holes on the corresponding one of the plates 351 and 352. The holes 363 on a top or a bottom end of the gaskets can be sealed in a similar manner to the holes 354s on the corresponding one of the end plates 351 and 352 to allow flow of fluid/gas suitable for electrolysis. The gaskets at opposite ends of the cell 300 are rotated 180 degrees to one another to match unsealed holes in the corresponding end plate.

FIG. 3D shows a set 370 of views of faces a single gas separating gasket 371. Two views 371a and 371b show opposite faces of the same gasket 371. Two channels 373a and 373b are formed on one end of the side 371a at the left top and bottom. One of the channels (for example 373b, lower) channel provides an inlet for fluid received from the connector and the other channel (373a, upper) provides a fluid outlet.

In assembly, the side 371a goes toward the metal plate 351 on the opposite side of the sealing gasket 361. If the side 371a is not oriented properly, no electrolyte flows into a compartment formed between the end plate and other plates of the cell 300. A view 371c of the gasket 371 shows one side of the gasket face 371a when rotated 180 degrees through the vertical plane. An assembly using one or more of the gaskets 371 will allow gases to be separated on each side of a membrane based on the channels 373a and 373b.

The gasket 371 has two faces, shown as 371a and 371b above. Two gaskets are required to make the gasket/membrane assembly 380.

The channels 373a and 373b within the gasket allow free flow of electrolyte into the chamber between the electrode and membrane. Additionally, the channels 373a and 373b allow free flow of electrolyte and gas to exit the chamber via each channel. The face of the assembly 300 opposing side 371a with the channels 373a and 373b can be connected in a flat manner to enable a tight seal of membrane to each gasket face. Through cut slots may not allow sealing. A channel is therefore used, preferably at 50% depth of the gasket width, routed or molded using a suitable thermoplastic material.

Each of the channels 373a and 373b can be routed, cut or molded to approximately 50% of the depth of the gasket. The entry and exit hole diameter controls the available volume within the channel. Hole size may be engineered to be large enough so as an appropriate fitting, such as tube fittings manufactured by Swagelok, may be fitted to each of the four holes in the gasket 371 for entry and exit of fluids. The channels 373a and 373b effectively facilitate sealing between hydrogen and oxygen chambers within the cell 300.

Soft materials such as rubbers can be used for the gasket 371. While rubbers cannot be routed but injection molded to produce the gasket. Harder plastics may also be used for the gasket 371 but require thin, soft rubber seal on the channel faces to seal against the electrodes. Alternatively, a specialized thermoplastic can be injected at a tested injection pressure to provide a suitably hard gasket which will still seal against electrode faces.

FIG. 3E shows the gasket assembly 380 separated into constituent components including two gaskets 381 and 383 and a membrane 382. The membrane is typically marginally smaller than the gaskets in terms of length and width to allow sealing to the gaskets. The gaskets 381 and 383 correspond to the gasket 371 and to the views 371b and 371a respectively. The membrane 382 is placed on the gasket 382 on the side shown (side 371b of FIG. 3D). Accordingly, the channels 373a and 373b are not visible in FIG. 3E as the channels are on the rear right side.

The gasket 383 is placed on membrane 382 on the opposite face to the gasket 381. Accordingly, a single gasket and membrane design can be used to construct the assembly 380. The gaskets 381 and 383, and similarly the gaskets 361 and 362 are typically formed from silicon or another material suitable for use in the electrolyte solution. The gaskets 381 and 383 can be formed using processes such as molding.

The membrane 382 is typically a relatively fine mesh of a plastics material. For example, mesh types are known as “500” mesh or up to “10,000” mesh depending on how fine the mesh is. The membrane may be typically a material such as polyamide or polyester or other nanopolymers but can be other materials. Suitable membranes may be manufactured by companies such as Fumatech, Zirfon and Nafion. Selection of a suitable membrane can depend on a number of factors including expected electrolyte concentration, metal used to form cell plates, reservoir size, cost and the like.

The pair of gaskets 381 and 383 with membrane 382 form the assembly 380, also referred to as a separation gasket assembly (SGA). The assembly 380 is typically assembled from bottom to top in order of 381, 382 and 383. A sealant, such as silicone adhesive (neutral cure roof & gutter), may be used on each mating face of the two gaskets 381 and 383 (not the membrane 382) and is applied prior to assembling. Commercial assembly may be performed without using adhesive in some implementations. Mating surfaces of the gaskets (such as 381 and 383) and membrane (382) should have sufficient space to allow a total seal on compression of the assembly. Assembly may be accomplished using guide rods screwed in to the four holes in the end plates using bored through connectors for example. The assembly 380 is performed using a suitably constructed jig or other similar industrial tools. The gasket design described has channels, not slots, thereby making gasket construction easier, and allowing a suitable permanent seal between gasket and membrane.

FIG. 3F shows a set 390 of electrode plates. The set 390 includes two electrode plates 391 and 392. The plates 391 and 392 are formed of metal such as stainless steel, titanium or nickel. Nickel can be preferred in some instances due to durability but at higher cost. The terminal metal plate 391 is a power connection plate. The plate 391 is placed on top of the sealing gasket 361. The full gasket assembly 380 is placed on top of terminal plate 391. A number of assemblies 380 are stacked on one another followed by the sealing gasket 362. The second electrode plate 392 is stacked on the sealing gasket 362. The electrode plate 391 is connected to receive power from the controller 104 via a protrusion or terminal connection 393. The plate 392 is connected to ground by a protrusion 394. The plates 391 and 392 are typically identical but have different connections when the cell 300 is assembled. FIG. 3G shows the neutral plate 340. The neutral plate 340 has no direct connections to the power supply applied to the cell 300. The neutral plate 340 has a size and shape to be fitted to one of the gaskets 381 and 382. The neutral plate 340 made of the same metal as the electrode plates 391 and 392.

The shapes of the holes, protrusions and plates described in FIGS. 3A to 3G can be varied. In prototypes developed for testing, electrodes are 15×15 cm square and the two terminal connection plates have that the protrusion/terminal connection (e.g. 393) provided for cable connection. However, in practice, depending on the scale and use of the system 100, the sizes of the plates can be varied.

FIG. 3H shows an example side view of an assembled electrolysis cell 300h with connections for use. The cell 300h is for illustrative purposes and dimensions shown therein are not to scale. The cell 300h is bounded by end plates 351 and 352 and secured using rods 320 and 330. The rods 320 and 330 are threaded through holes formed in the end plates 351 and 352 and are typically secured using bolts (not shown) or the like. Other mechanisms such as a bracket system may also be used to form the cell 300h.

A sleeve 399 is held between the plates 351 and 352. The sleeve 399 comprises the gasket 361, and the terminal plate 391 on the left side, the assemblies 380 and neutral plates 340 in the centre and the terminal plate 392 and gasket 362 on the right hand side, arranged in the same order as shown in FIG. 3A.

A conduit/pipe 396(lower end) is connected to each of the holes 354 of the end plate 352 for providing the electrolyte solution to the cell 300, for each hydrogen and oxygen compartment. A conduit 395(upper end) is connected to each of the holes 354 of the end plate 351 for receiving generated hydrogen and oxygen gases separately from each compartment and any transported electrolyte solution. The conduit 396 (lower end) delivers the electrolyte solution to the cell 300 for each separate hydrogen and oxygen compartments. The other side of each of the plates 351 and 352 are not shown but have similar connections.

The protrusions 393 and 394 of the terminal plates 391 and 392 are each connected to one of power input and ground. The connection can be established in a number of ways. For example, a slotted piece of copper can be configured to slide over each of the terminal connections 393 and 394. A bolt can be used to hold the connection tight onto the corresponding one of end plates 351 and 352.

When electrolyte solution is provided the cell 300h, fluid enters the sleeve 399 via the conduits 395 and 396 and flows to the lower channel (373b) of 371a and 371b (the lower channel in each of 381 and 383) and along the length of the sleeve 399. Application of voltage from the controller 104 causes the water to split and the resultant gases to be delivered to the reservoir 108. If the reservoir 180 comprises multiple reservoirs, each gas is formed from different reservoirs, one for hydrogen and one for oxygen. Accordingly, mixing of the gases can be prevented compared to using a single reservoir. In a particular cell, or if multiple cells are used, all gasket assemblies 380 are oriented the same way to prevent mixing of gaskets. Rotation of adjacent assembles 380 would increase mixing of gases.

The gaskets 381 and 382 must be oriented in a known position. The gas channel facing the negative terminal (one of plates 391 and 392) produces hydrogen gas, whereas the channel facing the positive terminal will produce oxygen gas. If one of the gasket assemblies is inserted in an incorrect orientation the generated gases can mix and potentially create HOH, which can explode upon attempted compression.

The gasket and plate components are held in place using the rods 320 and 330. The rods 320 and 330 are preferable zinc or nickel plated, high tensile threaded rods, 250 mm long through edge holes and tighten the complete assembly one centimeter, depending on gasket type density, for example shore 60 A. Assembly of the cell 300 is typically conducted in well lit, clean, dry conditions and represents an industrial process.

The example arrangements described use fifteen neutral plates. However, the number of plates can be varied based on the output voltage generated by the controller 104 or vice versa.

Tests have been conducted using the arrangements described to determine the rate of production of hydrogen gas through electrolysis based on the electrical energy used. Equation (4) below was used to determine the energy rate of hydrogen production in watt-hours per litre of hydrogen (Wh/L H₂).

Wh/L H2=Vcell×Icell×dutyfactor×seconds per 1L H2 evolved/3600 (4)

In Equation (4) Vcell is the voltage measured across one of the electrolysis cells 160, Icell is the current flowing through all the cells 160 in amps. The term “dutyfactor” in Equation (4) is the dutycycle/100 and seconds per litre H₂=time in seconds taken for one litre of hydrogen gas to be produced. The divisor 3600 relates to converting seconds to parts per hour.

Three tests were conducted using a frequency of 30 Hz or thirty pulses per second.

Test (A) used direct current (no pulse width modulation) and provided measurements of Vsupply=35.5 Vdc; Vcell=35.5 Vdc; Icell=19.9 Adc; Duty=100%; Dutyfactor=1; Secs per Litre H2=33

Energy per litre of hydrogen gas was therefore determined using Equation (4) to be 35.5×19.9×1×68.75/3600=6.48 Wh/L H₂. Reasonably close to industry standard (4-6 Wh/L).

Two sets of tests were conducted using pulse width modulation and different duty factors:

Test (B) provided measurements of. Vsupply=85 Vdc; Vcell=28.9; Icell=12; duty=5.6%; Dutyfactor=0.056; secs per Litre H2=53.28. Using Equation (4) a rate of 0.29 Wh/LH₂ was determined.

Test (C) provided measurements of: Vsupply=85V; Vcell=28.9 Icell=19.38; Duty=9.04; dutyfactor=0.0904; secs per litre=33. Using Equation (4) a rate of 0.46 Wh/LH₂ was determined.

The test are summarized in Table 1 below.

TABLE 1
tests A to C relating to duty factor

| | | | Litres per |
|---|---|---|---|
| Test | Duty Factor | Wh/LH₂ | minute of H₂ |
| A | 1 | 6.48 | 1.82 |
| B | 0.056 | 0.29 | 1.13 |
| C | 0.094 | 0.46 | 1.82 |

As shown by Table 1, the amount of power used across each cell to generate a litre of hydrogen gas decreased as the duty cycle decreased.

FIG. 4A shows results from tests conducted using between one and four electrolysis cells 160. Where more than one electrolysis cell 160 were used, the cells were connected in parallel.

FIG. 4A shows a graph 400 with a line 402 illustrating flow of hydrogen gas and a line 404 showing the energy required to generate a litre of hydrogen gas. Appendix A shows a data set collected in the tests conducted that led to generation of the graph 400. As shown by the line 402 and the data of Appendix A, the flow of hydrogen gas increases as the number of cells increases. As shown by the line 404 and the data of Appendix A the energy required to generate a litre of hydrogen decreases as the number of cells increases. The largest decrease is evident as the number of cells increases from one cell to two cells.

Appendix B shows test conducted with different concentrations of KOH and voltage in the electrolyte reservoir 108. Effectively, less voltage can be used for higher concentrations of electrolyte. As described above, a preferred implementation of the system 100 uses a concentration of 100 gKOH/L, an input voltage in a range of 90V and a duty cycle of between 1% and 10% or ranges thereof. Higher concentrations of KOH up to about 25% may be used.

An indicative test was also conducted using the system 100 referred to herein as a “battery recharge test”. The battery recharge test related to conducting five different tests to displace one kilogram of water with the gases generated by electrolysis. Before the five tests, a series of batteries was fully charged, allowed one day to settle without charge and then connected as the input voltage 102. Once each kilogram of water was displaced the electrolysis system was switched off. The batteries 102 were allowed approximately fifteen minutes to rest between each test. At the conclusion of the five tests the batteries were allowed one hour to rest and reach a stable rest voltage. Once the rest period was over, the amount of energy required to charge the battery bank to full (return to the starting stable voltage) was measured. Data collected for each test is provided in Appendix C.

The average energy required to generate a litre of hydrogen gas for the five tests of the battery recharge test was found to be 0.255 Wh/L. The average amount of energy required to generate a litre of gas comprising hydrogen and oxygen gas for the five tests was found to be 0.166 Wh/L.

The average time to recharge the batteries after the one hour rest was found to be 6 minutes. The energy required to recharge the batteries to the starting voltage was measured using a digital charger, storing accumulated Ah and found to be 0.016 Ah. Using a measured recharge voltage of 76.3V the recharge requirement provided 1.2208 Wh to generate a total 5 litres of hydrogen gas, or 0.244 Wh/L of hydrogen gas (0.159 Wh/L per litre of oxygen and hydrogen gas combined). In the test of Appendix C, the energy required to charge the batteries expressed in terms of Wh per litre was less than the average energy required to generate a litre of hydrogen gas. The test provided a mechanism to determine the proximity of energy used for gas generation rather than determine whether recharge energy would be more or less than that calculated from measurements aside from recharge. Battery voltage provides an indication of state of charge and of energy capacity. This test is preferably carried out using batteries in good condition and optimally charged before each test procedure and allowed to reach the resting battery state of charge (SOC) for at least 24 hours prior to the testing. At each end of the five one litre hydrogen tests, power is switched off and batteries are allowed 15 minutes to rest and stabilize.

Another test conducted using the system 100 is referred to as a fuel cell test. The fuel cell test involved providing the hydrogen gas generated by the system 100 to a fuel cell using a system of micro pumps. A pressure controller relay was used to turn the pumps and the electrolyser system 100 on and off automatically according to pressure control only. The electrolysis system 100 turned on for a certain period and then turned off. As shown in Appendix D, the fuel cell was provided a maximum load up to 24.2 W. A one-metre long, 10 millimetre diameter tube holding a regenerated quantity of mixed molecular sieve 5 a (5 angstrom pore size)/indicating silica gel was used as a drier. There was no indication of change of colour in the silica gel in a one hour run time in this or other similar tests.

The test showed that once the electrolysis system 100 was turned off, the fuel cell continued to operate for some further time according to min/max pressure settings within a digital pressure controller. The cycle time of Appendix D provides the cycle measurements. The electrolyser on and off times are shown in Appendix D. Continuous operation of the system 100 was not required to operate the fuel cell over the full cycle time. Accordingly, the system 100 need not be operated continuously to operate a fuel cell of this type. Non-continuous operation can provide benefits such as delay of wear and tear to components and decreased energy loss due to heating.

In the tests of Appendix D silica gel was used to dry the generated hydrogen gas. In other implementations, a pressure swing apparatus (PSA) could be used to dry the hydrogen gas for provision to a fuel cell.

The electrolysis system 100 of FIG. 1 can be used to generate hydrogen gas as stored in the container 110. The generated hydrogen gas can be used to generate electricity using a fuel cell. Fuel cells such as those manufactured by Ballard Power and Horizon Fuel Cell Technologies for example are suitable for converting hydrogen to electricity.

The arrangements described are applicable to the energy generation industries and particularly for the hydrogen and electricity generating industries. As described above, the arrangements described achieve hydrogen generation through use of one or more of decreased duty cycle, use of up to four electrolysis cells connected in parallel and KOH concentration.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

### Appendix A—Tests Relating to Using Between 1 and 4 Electrolysis Cells

Measurements for test associated with FIG. 4A are shown in Table 2 below.

TABLE 2
measurements taken in test for FIG. 4A

| | | | | | Total | H2 | | | |
|---|---|---|---|---|---|---|---|---|---|
| | | | | duty | gas | flow | Wh/L | LPM | |
| # Cells | Vin | Vcell | Icell | factor | flow s/L | s/L | H2 | H2 | I cells1-4 |
| 1 | 74.2 | 28.1 | 2.5 | 0.035 | 123.76 | 185.64 | 0.127 | 0.323 | 2.5 |
| 2 | 74.2 | 27.9 | 5.26 | 0.0337 | 75.37 | 113.055 | 0.155 | 0.531 | 2.58, 2.68 |
| 3 | 74.1 | 27.8 | 7.8 | 0.032 | 57.95 | 86.925 | 0.168 | 0.690 | 2.4, 2.5, 2.9 |
| 4 | 73.8 | 27.2 | 9.1 | 0.0292 | 50.13 | 75.195 | 0.151 | 0.798 | 2.2 ,2.3, 2.4, 2.2 |

The measurement above are for test run with between one and four electrolysis cells 106 using a frequency of 29 Hz. In the measurements above # Cells shows the number of electrolysis cells used, Vin shows the voltage provided by the power supply 102, and Vcell is an average voltage measured across each of the electrolysis cells 106. Icell is the total current measured across each cell or number of cells as more cells were connected to a total of four cells. When four cells were connected, current for each cell was measured and included as I cells 1-4.
“Duty factor” is the duty factor of the square wave output by the controller 104. “Total gas flow” is the overall gas flow generated in terms of seconds per litre and “H2 flow” is the hydrogen gas flow generated in terms of seconds per litre. The column “Wh/L H2” shows the energy required (in terms of Wh) per litre of hydrogen gas generated. The column “ICells1-4” shows the current measured flowing through each of the cells 160 in amps. The tests were carried out using 15 neutral plates, 100 g KOH/L and using 6×12V batteries as the supply 102.
Other tests were conducted using duty cycles of approximately 5% (Table 3) and 8% (Table 4) as shown below. Only four cells were used in these two tests.

TABLE 3
Tests for 4 cells

| | | | | | H2 | LPM | Wh/L |
|---|---|---|---|---|---|---|---|
| # Cells | Vin | Vcell | Icell | Dutyfactor | secs/L | H2 | H2 |
| 4 | 72.2 | 28.5 | 13.3 | 0.051 | 39.72 | 1.51 | 0.213 |

TABLE 4
Tests for 4 cells

| | | | | | H2 | LPM | Wh/L |
|---|---|---|---|---|---|---|---|
| # Cells | Vin | Vcell | Icell | Dutyfactor | secs/L | H2 | H2 |
| 4 | 71.3 | 29.77 | 21.4 | 0.077 | 23.4 | 2.56 | 0.319 |

In the tests conducted relating to Table 3, an average energy for 4 cells required (in terms of Wh) per litre of hydrogen gas generated was determined to be 0.213 Wh/l and an average hydrogen gas flow of 1.511 LPM (litres per minute) was determined.
In the tests conducted relating to Table 4, an average energy for 4 cells required (in terms of Wh) per litre of hydrogen gas generated was determined to be 0.319 Wh/l and an average hydrogen gas flow of 2.564 LPM was determined.

### Appendix B—Tests Using Different Concentrations of Electrolyte Solution

Measurements taken for generating the graphs 410 to 440 is shown in tables 5-7 below.

TABLE 5
measurements for tests using 5 g KOH/L, 20 Neutrals, 1 cell, 10% Duty.

| | | | | | | | Total | |
|---|---|---|---|---|---|---|---|---|
| Number | | | | | | | Gas | mls/min |
| of | Vdc In | Vrms | Irms | | Duty | Flow | Flow | Total |
| Batteries | 5 g/L | Cell | Cell | Watts | Watts | secs/100 ml | secs/L | Gas |
| 6 | 79.3 | 44.1 | 0.612 | 26.99 | 2.70 | 57.6 | 576 | 104 |
| 7 | 92.3 | 46.2 | 0.83 | 38.35 | 3.83 | 36.91 | 369.1 | 163 |
| 8 | 104.7 | 47.8 | 1.01 | 48.28 | 4.83 | 30.1 | 301 | 199 |
| 9 | 117.9 | 48.95 | 1.138 | 55.71 | 5.57 | 24.49 | 244.9 | 245 |
| 10 | 130.8 | 50.32 | 1.33 | 66.93 | 6.69 | 21.26 | 212.6 | 282 |
| 11 | 142.8 | 52.52 | 1.62 | 85.08 | 8.51 | 17.81 | 178.1 | 337 |
| 12 | 155.5 | 53.27 | 1.75 | 93.22 | 9.32 | 16.69 | 166.9 | 359 |
| 13 | [symbol] | 54.15 | 1.89 | 102.34 | 10.23 | 14.6 | 146 | 411 |

| H2 | mls/min | Total Gas | | |
|---|---|---|---|---|
| Flow | H2 5 g | Wh/L | Input Energy | Freq |
| secs/L | KOH/L | 5 g KOH/L | Wh/L H2 | (Hz) |
| 864 | 69 | 0.432 | 0.648 | 484 |
| 554 | 107 | 0.393 | 0.590 | 487 |
| 452 | 132 | 0.404 | 0.605 | 492 |
| 367 | 162 | 0.379 | 0.568 | 465 |
| 319 | 186 | 0.395 | 0.593 | 465 |
| 267 | 222 | 0.421 | 0.631 | 505 |
| 250 | 237 | 0.432 | 0.648 | 483 |
| 219 | 271 | 0.415 | 0.623 | 471 |

TABLE 6
measurements for tests using 10 g KOH/L, 20 neutrals, 1 cell, 10% Duty.

| | | | | | | | Total | |
|---|---|---|---|---|---|---|---|---|
| | | | | | Duty | | Gas | mls/min |
| # | Vdc In | Vrms | Irms | | Watts | Flow | Flow | Total |
| Batteries | 10 g/L | Cell | Cell | Watts | (10 g KOH/L) | secs/100 ml | secs/L | Gas |
| 6 | 79 | 44.7 | 1.11 | 49.62 | 4.96 | 30.59 | 305.9 | 196 |
| 7 | 91.8 | 46.2 | 1.49 | 68.84 | 6.88 | 20.44 | 204.4 | 294 |
| 8 | [symbol] | 47.5 | 1.85 | 87.88 | 8.79 | 15.9 | 159 | 377 |
| 9 | 117.3 | 48.86 | 2.28 | 111.40 | 11.14 | 12.17 | 121.7 | 493 |
| 10 | 130.2 | 49.92 | 2.71 | 135.28 | 13.53 | 91.35 | 91.35 | 657 |
| 11 | 142.7 | 51 | 3.16 | 161.16 | 16.12 | 7.825 | 78.25 | 767 |
| 12 | 154.5 | 52.25 | 3.64 | 190.19 | 19.02 | 6.705 | 67.05 | 895 |
| 13 | 166.7 | 52.7 | 3.97 | 209.22 | 20.92 | 6.48 | 64.8 | 926 |

| H2 | mls/min | Total Gas | | |
|---|---|---|---|---|
| Flow | H2 10 g | Wh/L | Input Energy | Freq, |
| secs/L | KOH/L | 10 g KOH/L | Wh/L H2 | Hz |
| 459 | 129 | 0.422 | 0.632 | 483 |
| 307 | 194 | 0.391 | 0.586 | 477 |
| 239 | 249 | 0.388 | 0.582 | 480 |
| 183 | 325 | 0.377 | 0.565 | 490 |
| 137 | 433 | 0.343 | 0.515 | 493 |
| 117 | 506 | 0.350 | 0.525 | 504 |
| 101 | 591 | 0.354 | 0.531 | 513 |
| 97 | 611 | 0.377 | 0.565 | 498 |

TABLE 7
measurements for tests using 15 g KOH/L, 20 neutrals, 1 cell, 10% Duty.

| | | | | | | | Flow | |
|---|---|---|---|---|---|---|---|---|
| | | | | | Duty | | secs/L | mls/min |
| # | Vdc In | Vrms | Irms | | Watts | Flow | Total | Total |
| Batteries | 15 g/L | Cell | Cell | Watts | (15 g KOH/L) | secs/100 ml | Gas | Gas |
| 6 | 80 | 44.5 | 1.49 | 66.31 | 6.63 | 22.4 | 224 | 268 |
| 7 | [symbol] | 46.2 | 1.97 | 91.01 | 9.10 | 15.53 | 155.3 | 386 |
| 8 | 107.5 | 48.1 | 2.68 | 128.91 | 12.89 | 10.94 | 109.4 | 548 |
| 9 | 118.3 | 49.1 | 3.13 | 153.68 | 15.37 | 8.72 | 87.2 | 688 |
| 10 | 131.3 | 49.6 | 3.55 | 176.08 | 17.61 | 7.26 | 72.6 | 826 |
| 11 | 143.2 | 50.3 | 4 | 201.20 | 20.12 | 6.315 | 63.15 | 950 |
| 12 | 155.4 | 51.3 | 4.64 | 238.03 | 23.80 | 5.705 | 57.05 | 1052 |
| 13 | 167.2 | 52 | 5.32 | 276.64 | 27.66 | 4.81 | 48.1 | 1247 |

| H2 | mls/min | Total Gas | | |
|---|---|---|---|---|
| Flow | H2 15 g | Wh/L | Input Energy | Freq, |
| secs/L | KOH/L | 15 g KOH/L | Wh/L H2 | Hz |
| 336 | 177 | 0.413 | 0.619 | 492 |
| 233 | 255 | 0.393 | 0.589 | 491 |
| 164 | 362 | 0.392 | 0.588 | 528 |
| 131 | 454 | 0.372 | 0.558 | 524 |
| 109 | 545 | 0.355 | 0.533 | 500 |
| 95 | 627 | 0.353 | 0.529 | 496 |
| 86 | 694 | 0.377 | 0.566 | 507 |
| 72 | 823 | 0.370 | 0.554 | 517 |

### Appendix C—Measurements for Battery Recharge Test

Data used for generating one litre of hydrogen five times is shown in Table 8 below. Data relating to recharging the batteries is shown in Table 9 below.

TABLE 8
data measured in 5 tests displacing one kilogram of water with generated hydrogen gas.

| | Vbatt | | | | | CRO + | CRO | |
|---|---|---|---|---|---|---|---|---|
| Time | start | Vwork | Vend | Vcell | Icell | width | PRD | Dutyfactor |
| 14:11 | 76.4 | 72.7 | 75.7 | 27.3 | 10 | 1.48 | 35.16 | 0.042 |
| 14:22 | 75.7 | 73 | 75.6 | 27.3 | 10 | 1.52 | 34.96 | 0.043 |
| 14:31 | 75.6 | 73 | 75.6 | 27.2 | 10 | 1.52 | 34.8 | 0.044 |
| 14:40 | 75.7 | 73 | 75.7 | 27.6 | 10 | 1.52 | 34.64 | 0.044 |
| 14:49 | 75.7 | 73.1 | 75.8 | 27.6 | 10 | 1.52 | 34.56 | 0.044 |
| Averages | 75.82 | 72.96 | 75.68 | 27.4 | 10 | 1.51 | 34.82 | 0.043 |

| O2 grams water | | | | | |
|---|---|---|---|---|---|
| remaining | mL O2 | 1 L H2 secs | LPM H2 | Wh/L H2 | Test # |
| 427 | 573 | 89.34 | 0.672 | 0.285 | 1 |
| 492 | 508 | 78.18 | 0.767 | 0.258 | 2 |
| 462 | 538 | 78.75 | 0.762 | 0.260 | 3 |
| 469 | 531 | 70.87 | 0.847 | 0.238 | 4 |
| 481 | 519 | 67.91 | 0.884 | 0.229 | 5 |
| 466.2 | 533.8 | 77.01 | 0.786 | 0.254 | Average |

| Total O2 L | 2.669 | | | |
|---|---|---|---|---|
| Total L, H2 + O2 | 7.669 | | | |
| Secs/L H2 + O2 | 50.21 | | | |
| 14:51 | Finished | Comment | Avg Wh/L H2 | 0.255 |
| 14:59 | 75.8 | | Avg Wh/L H2 + O2 | 0.166 |
| 15:11 | 76.0 | | | |
| 16:11 | 76.2 | Before | | |
| | | Charge | | |

TABLE 9
data relating to recharging the batteries after completion of the test of Table 8.

| Time Taken, mins | Vbatt | Ah | Vcharge | Wh/SL | Wh/L H2 | Wh/L H2 + O2 | Comment | |
|---|---|---|---|---|---|---|---|---|
| 2 | 76.4 | 0.009 | 76.3 | 0.6867 | 0.137 | 0.090 | almost stable | |
| 6 | 76.4 | 0.016 | 76.3 | 1.2208 | 0.244 | 0.159 | Stable 76.3/4 | |
| Precharge Battery CCA | | 635 | 610 | 620 | 630 | | 605 | 625 |
| Post Charge, Battery CCA 1 -> 6 | | 635 | 610 | 620 | 630 | | 600 | 625 |

The data in Tables 8 and 9 is provided as follows:
Vbatt start=battery voltage before start of any testing.
V work=battery voltage during a test.
V end=battery voltage at immediate end of a test
V and I cell=voltage and current (amps) at cell.
CRO+width=oscilloscope measured peak or pulse width in milliseconds (ms)
CRO PRD=oscilloscope measured total cycle time in milliseconds (ms)
Duty Factor=CRO+width/CRO PRD.
Values shown here describe a duty cycle of 4.3% average.
The Duty Watts used will be Vcell×Icell×Dutyfactor.
O2 grams water remaining=millilitres or grams of water remaining from the initial 1000 g weighed at start of test after oxygen displaced the water.
1 L H2 sec s=the number of seconds taken to displace 1000 g or 1000 mls of water, giving exactly 1 L H2
LPM H2=Litres per minute H2 evolved
Wh/L H2=the Watt Hours used per one litre of H2 evolved

### Appendix D—Measurements for Fuel Cell Operation Test

### Cycle Test

TABLE 10
fuel cell operation test. Horizon 20 Watt
The Cycle Test indicates that the purity of hydrogen is high.

| | | FUEL CELL | | | | | | |
|---|---|---|---|---|---|---|---|---|
| | | Load Bulb = 12 V car bulb | | | “Cycle Time” | | | |
| | | | | Fuel | is automatic | | | |
| | | | | Cell | Power | Power | | |
| | | Fuel | | Load, | ON | OFF | Cycle | |
| | Total Load | Cell, | FuelCell, | measured | Time, | Time, | Time, | % ON |
| Load Bulb, Watts | BULBS, W | V | I | Watts | secs | secs | secs | Time |
| 5 | 5 | 10.25 | 0.46 | 4.7 | 51.86 | 75.27 | 127.13 | 40.8% |
| 10 | 10 | 9.93 | 0.77 | 7.7 | 79.73 | 94.25 | 173.98 | 45.8% |
| 10 + 5 | 15 | 9.62 | 1.22 | 11.4 | 66.81 | 73.01 | 139.82 | 47.8% |
| 21 | 21 | 9.16 | 1.82 | 16.9 | 73.18 | 64.6 | 137.78 | 53.1% |
| 21 + 5 | 26 | 9.31 | 2.19 | 19.6 | 73.32 | 70.64 | 143.96 | 50.9% |
| 21 + 10 | 31 | 8.8 | 2.45 | 21.8 | 70.73 | 55.8 | 126.53 | 55.9% |
| [symbol] | [symbol] | [symbol] | [symbol] | [symbol] | [symbol] | [symbol] | [symbol] | 55.9% |

1. An electrolysis system, comprising:
a power supply configured to provide an input voltage;
a controller configured to receive the input voltage and output a pulse width modulated voltage, the output voltage being a 30V square wave having a variable duty cycle in the range of 1% to 10%; and
at least one electrolysis cell configured to receive the output voltage, each electrolysis cell comprising a plurality of metal plates, each electrolysis cell being configured for receiving water containing an electrolyte to split the water when the output voltage is received.

2. The electrolysis system according to claim 1, wherein the input voltage is between 75 Vdc and 250 Vdc.

3. The electrolysis system according to claim 1, wherein the square wave has a frequency of 30 Hz.

4. The electrolysis system according to claim 1 wherein the at least one electrolysis cell comprises four electrolysis cells connected in parallel.

5. The electrolysis system according to claim 1, wherein a concentration of the electrolyte in the water is 100 g KOH per litre.

6. The electrolysis system according to claim 1, wherein each of the at least one electrolysis cells comprises fifteen neutral plates and two terminal plates, each of the terminal plates forming an end of the electrolysis cell.

7. The electrolysis system according to claim 6, wherein the input voltage is varied such that a voltage between each of the plates of the at least one electrolysis cell is in the range of 1.2V to 2V.

8. The electrolysis system according to claim 1, wherein the duty cycle is varied based upon voltage measured across the at least one electrolysis cell.

9. A method of performing electrolysis, the method comprising:
receiving, at a controller, an input voltage;
generating, by the controller using the input voltage, a pulse width modulated output voltage, the output voltage being a 30V square wave having a variable duty cycle in a range of 1% to 10%; and
receiving, by at least one electrolysis cell, the output voltage, each electrolysis cell comprising a plurality of metal plates, each electrolysis cell being configured for receiving water containing an electrolyte to split the water when the output voltage is received.
